(19) United States
(12) Patent Application Publication
(10) Pub. No.: US 2003/0002467 A1
(43) Pub. Date: Jan. 2, 2003

(54) Internet protocol framing using radio link protocol

(76) Inventor: Nikolai K.N. Leung, Takoma Park, MD (US)

Correspondence Address: QUALCOMM Incorporated, Attn: Patent Department, 5775 Morehouse Drive, San Diego, CA, 92121-1714, US

(21) Appl. No.: 09/895,655

(22) Filed: Jun. 29, 2001

(51) Int. Cl. H04Q 7/24

(52) U.S. Cl. 370/338; 370/474; 370/476

(57) ABSTRACT

Techniques for supporting IP framing with lower computational load are disclosed herein. In one aspect, IP packets are partitioned into RLP frames. Subsequently, the IP packets, partitioned into RLP frames, are transmitted on a wireless data link employing RLP. In another aspect, received RLP frames are reconstructed into IP packets. The RLP framing is used to supply frame boundaries for the reconstructed IP packets. These aspects have the benefit of using the underlying frame transmission and framing properties of RLP, thus minimizing computational load associated with framing, transmitting, and receiving IP packets. The techniques described herein apply equally to both access points and access terminals.

### BACKGROUND

1. Field

The present invention relates generally to communications, and more specifically to a novel and improved method and apparatus for generating Internet Protocol framing using the Radio Link Protocol.

2. Background

Wireless communication systems are widely deployed to provide various types of communication such as voice, data, and so on. These systems may be based on code division multiple access (CDMA), time division multiple access (TDMA), or some other modulation techniques. A CDMA system provides certain advantages over other types of systems, including increased system capacity.

A CDMA system may be designed to support one or more CDMA standards such as (1) the “TIA/EIA-95-B Mobile Station-Base Station Compatibility Standard for Dual-Mode Wideband Spread Spectrum Cellular System” (the IS-95 standard), (2) the “TIA/EIA-98-C Recommended Minimum Standard for Dual-Mode Wideband Spread Spectrum Cellular Mobile Station” (the IS-98 standard), (3) the standard offered by a consortium named “3rd Generation Partnership Project” (3GPP) and embodied in a set of documents including Document Nos. 3G TS 25.211, 3G TS 25.212, 3G TS 25.213, and 3G TS 25.214 (the W-CDMA standard), (4) the standard offered by a consortium named “3rd Generation Partnership Project 2” (3GPP2) and embodied in a set of documents including “TR-45.5 Physical Layer Standard for cdma2000 Spread Spectrum Systems,” the “C.S0005-A Upper Layer (Layer 3) Signaling Standard for cdma2000 Spread Spectrum Systems,” and the “C.S0024 cdma2000 High Rate Packet Data Air Interface Specification” (the cdma2000 standard), and (5) some other standards. These named standards are incorporated herein by reference. A system that implements the High Rate Packet Data specification of the cdma2000 standard is referred to herein as a high data rate (HDR) system. The HDR system is documented in TIA/EIA-IS-856, “CDMA2000 High Rate Packet Data Air Interface Specification”, and incorporated herein by reference. Proposed wireless systems also provide a combination of HDR and low data rate services (such as voice and fax services) using a single air interface.

An example of a wireless data communication system that does not employ CDMA is the GPRS system, another standard offered by the 3GPP, embodied in a set of documents including 3G TS 23.060 and related documents (the GPRS standard).

Data systems commonly employ the Internet Protocol (IP) to facilitate data transfer. Systems employing IP send data in packets, and rely on the layer below IP, the link layer, to keep track of packet framing—that is, the start and end of each IP packet. Some CDMA systems, such as those employing the IS-95 standard, run IP on the Point-to-Point Protocol (PPP). PPP, in turn, uses a framing protocol named High Data Link Control (HDLC). For more information on using HDLC for PPP, see IETF RFC 1662.

In addition to utilizing a framing protocol, such as HDLC, PPP may run on a lower level protocol. For example, cdma2000 systems run PPP over Radio Link Protocol Type 3, hereinafter RLP. For details on cdma2000 data services, see generally the TIA/EIA/IS-707 family of documents, “Data Service Options for Spread Spectrum Systems.” For details on RLP specifically, reference TIA/EIA/IS-707-A-2.10, “Data Service Options for Spread Spectrum Systems: Radio Link Protocol Type 3.” (the RLP standard) RLP provides an octet stream transport service over forward and reverse traffic channels. RLP is unaware of higher layer framing: it operates on a featureless octet stream, delivering octets in the order received.

In HDLC framing, flags are used to identify the start and end of a packet. The particular flag used is the binary sequence 01111110. The use of these flags causes some processing to be completed in both the transmitter preparing data for transmission and the receiver that receives that data. In the transmitter, the data sequence that is being transmitted must be monitored for the appearance of the flag sequence. If that sequence exists in the data, an escape flag must be inserted to prevent the receiver from falsely identifying that data sequence as the flag delimiting the end of the packet. In the receiver, the incoming data must be monitored to detect start and stop flags, as well as any escape characters which must be replaced with the original data sequence in the received data stream.

Use of a framing protocol, such as HDLC, that requires monitoring of both the outgoing and incoming data adds to the computational load on the central processing unit (CPU) tasked to perform the monitoring. The computational load increases proportionally as the data rates increase. Newer wireless systems, examples of which are given above, support data rates that are higher than those supported by IS-95. The trend toward higher data rates in wireless systems is likely to continue. There is therefore a need in the art for support of IP, and its associated framing, with lower computational load requirements.

### SUMMARY

Embodiments disclosed herein address the need for supporting IP framing with lower computational load. In one aspect, IP packets are partitioned into RLP frames. Subsequently, the IP packets, partitioned into RLP frames, are transmitted on a wireless data link employing RLP. In another aspect, received RLP frames are reconstructed into IP packets. The RLP framing is used to supply frame boundaries for the reconstructed IP packets. These aspects have the benefit of using the underlying frame transmission and framing properties of RLP, thus minimizing computational load associated with framing, transmitting, and receiving IP packets. The techniques described herein apply equally to both access points and access terminals. Various other aspects of the invention are also presented.

The invention provides methods and system elements that implement various aspects, embodiments, and features of the invention, as described in further detail below.

### BRIEF DESCRIPTION OF THE DRAWINGS

The features, nature, and advantages of the present invention will become more apparent from the detailed description set forth below when taken in conjunction with the drawings in which like reference characters identify correspondingly throughout and wherein:

FIG. 1 is a wireless communication system that supports a number of users, and which can implement various aspects of the invention;

FIG. 2 depicts a generalized block diagram of a wireless data system;

FIG. 3 is a transmitter configured in accordance with various aspects of the invention;

FIG. 4 diagrams the composition of frames for IP framing over RLP; and

FIG. 5 is a receiver configured in accordance with various aspects of the invention.

### DETAILED DESCRIPTION

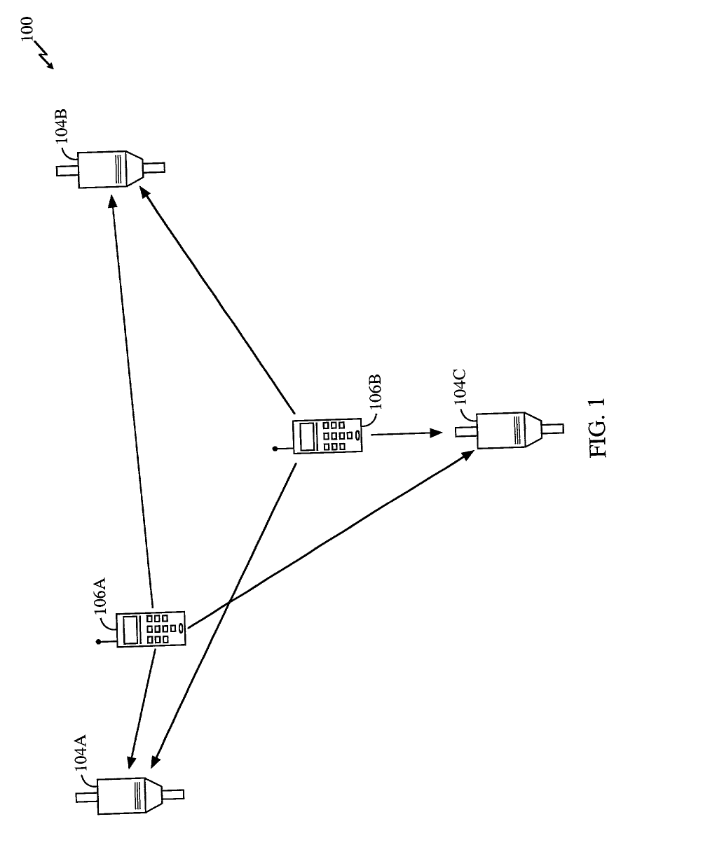

FIG. 1 is a diagram of a wireless communication system 100 that supports a number of users, and which can implement various aspects of the invention. System 100 may be designed to support one or more standards and/or designs (e.g., the IS-95 standard, the cdma2000 standard, the HDR specification, the GPRS standard). For simplicity, system 100 is shown to include three access points 104 (which may also be referred to as base stations) in communication with two access terminals 106 (which may also be referred to as remote terminals or mobile stations). The access point and its coverage area are often collectively referred to as a “cell”.

When certain CDMA systems are being implemented, each access terminal 106 may communicate with one (or possibly more) access points 104 on the forward link at any given moment, and may communicate with one or more access points on the reverse link depending on whether or not the access terminal is in soft handoff. The forward link (i.e., downlink) refers to transmission from the access point to the access terminal, and the reverse link (i.e., uplink) refers to transmission from the access terminal to the access point.

For clarity, unless otherwise specified, the examples used in describing this invention will assume access points as the originator of signals and access terminals as receivers of those signals, i.e. the forward link. Those skilled in the art will understand that access terminals as well as access points can be equipped to transmit data as described herein and the aspects of the present invention apply in those situations as well, i.e., the reverse link. The word “exemplary” is used exclusively herein to mean “serving as an example, instance, or illustration.” Any embodiment described herein as “exemplary” is not necessarily to be construed as preferred or advantageous over other embodiments.

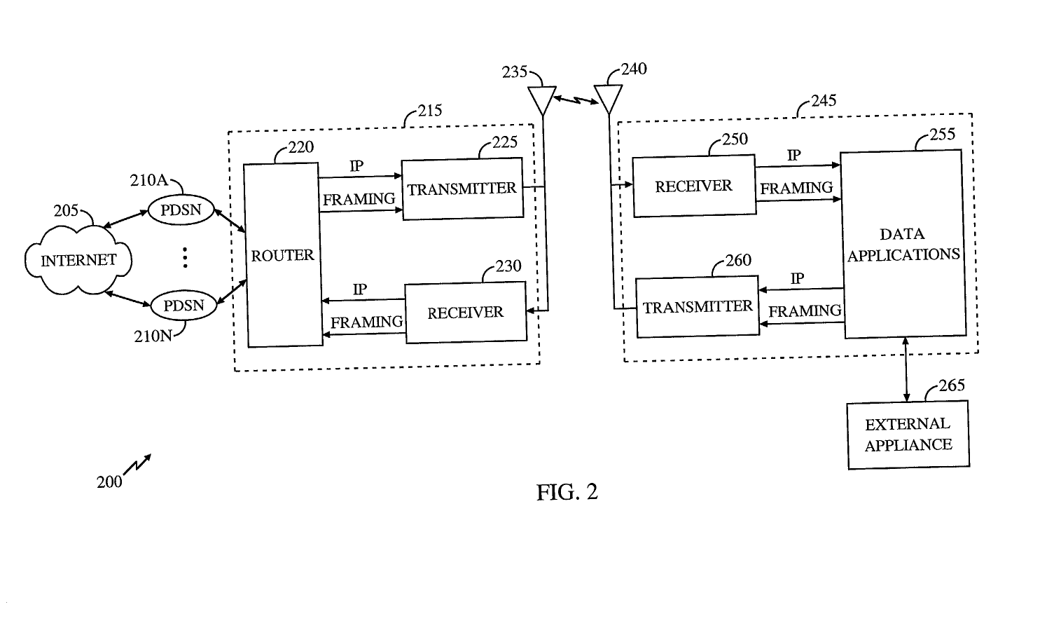

FIG. 2 is a generalized block diagram of wireless data system 200. Access point, or base station, 215 communicates over a wireless link via antenna 235 with antenna 240 of access terminal, or mobile station, 245. Base station 215 is connected to one or more packet data service nodes (PDSNs) 210A-210N, which in turn are connected to Internet 205. Data is transferred between the Internet 205, PDSNs 210A-210N and base station 215 using IP packets.

Router 220 provides routing services for base station 215. It receives IP data from Internet 205 via PDSNs 210A-210N, and perhaps from data sources internal to the base station, for transmission over the wireless link through transmitter 225.

Transmission from base station 215 to mobile station 245 is commonly known as the forward link. Transmitter 225 receives the IP packets, as well as their associated frame boundaries, and prepares the data for transmission via antenna 235, according to the air interface standard being utilized. The transmitted signals are received at mobile station 245 through antenna 240, and delivered to receiver 250. Receiver 250 performs operations necessary to convert the transmitted signals to baseband, demodulates the data, and delivers the data in IP packets, along with associated frame boundaries, to block 255, data applications. Block 255 represents the numerous data applications that may be operating in mobile station 245.

Connected to data applications block 255 is an optional external appliance 265 (there can be more than one external appliance), which may be a portable computer or other data appliance externally connected to the access terminal, or mobile station 245. The link between data applications 255 and external appliance 265 may be an IP link, or it may be any other type of link (including a wireless link such as Bluetooth). Alternatively, the link to external appliance 265 may come directly from receiver 250 (not shown).

Data transmission from mobile station 245 to base station 215 is commonly known as the reverse link. Data from external appliance 265 or data applications 255 is delivered to transmitter 260 via IP packets (and associated frame boundaries). Transmitter 260 prepares the data for transmission via antenna 240, according to the air interface being utilized for the reverse link. The transmitted signals are received at base station 215 through antenna 235, and delivered to receiver 230. Receiver 230 performs operations necessary to convert the transmitted signals to baseband, demodulates the data, and delivers the data in IP packets, along with associated frame boundaries, to router 220 for delivery to its final destination via PDSNs 210A-210N and Internet 205 (in some cases, the destination of the data may be within base station 215).

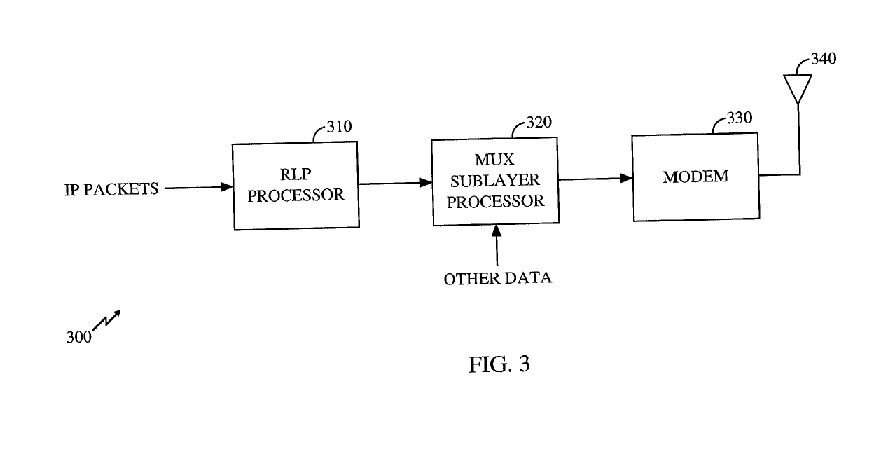

FIG. 3 depicts transmitter 300, which is suitable for deployment in wireless data system 200 as either transmitter 225 or transmitter 260, as shown in FIG. 2. In transmitter 300, IP packets are delivered to RLP processor 310. The IP packets are processed into RLP frames, which are delivered to mux sublayer processor 320. Mux sublayer processor 320 receives the RLP frames, as well as other data, and multiplexes them together and delivers them to modem 330, which performs physical layer processing for transmission via antenna 340 (antenna 340 corresponds to either antenna 235 or 240 in reference to FIG. 2). Modem 330 processes the physical layer according to the air interface being deployed. (The physical layer may differ on the forward and reverse links.)

In the exemplary embodiment, the cdma2000 standard is deployed, and the PPP protocol is used to transmit and receive IP packets. In this example, the IP packets delivered to RLP processor may be PPP frames. HDLC is not needed to provide framing, since the RLP framing will be utilized. This relieves the transmitter of the burden of monitoring the transmitted data for appearances of start and stop flags, and replacing them with escape sequences, as described in the background section above.

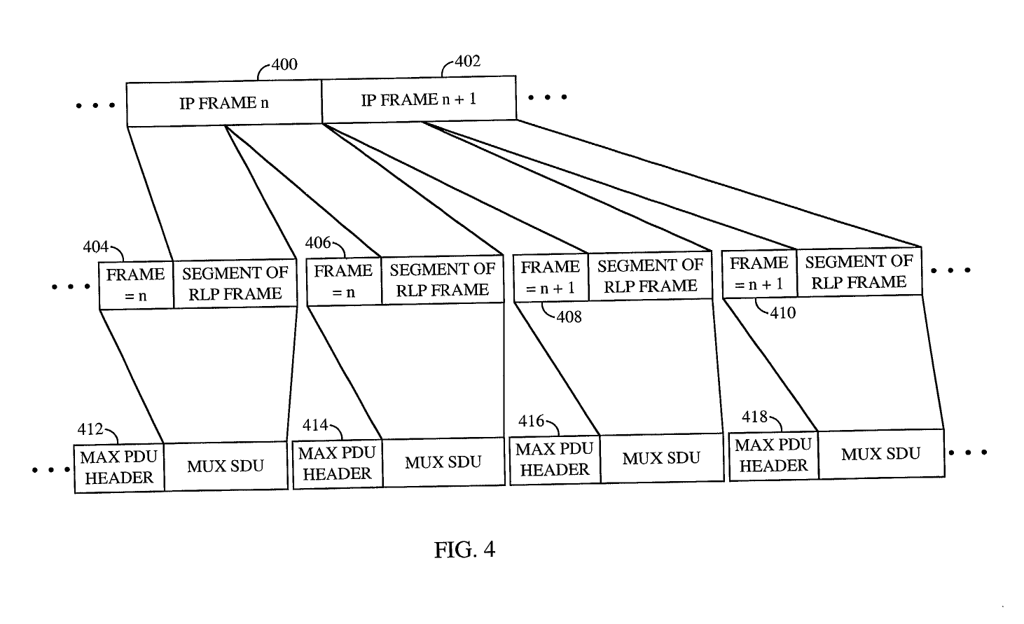

FIG. 4 details the frame composition for the procedures just described. IP packets (or PPP frames) are received in RLP processor 310. Examples of these are IP frame n 400 and IP frame n+1 302. Each IP frame will be encapsulated into one RLP frame, so that the RLP framing can be used throughout the radio link and no additional frame processing will be required. An RLP frame can consist of up to 4096 octets. RLP processor 310 increments a frame sequence and prepends a frame number to each RLP frame. Refer to the RLP standard for details on how RLP is used.

The RLP frames are delivered to mux sublayer processor 320, where they are processed, along with any other data streams, into units for transmission known as multiplexed sublayer protocol data units (or mux PDUs). Sometimes an RLP frame cannot be carried across one mux PDU, and so it must be spread across multiple mux PDUs. In FIG. 4, frames 404 and 406 show two segments of RLP frame n (associated with IP frame n 400), with the frame number prepended as described above. Similarly, frames 408 and 410 correspond to RLP frame n+1 (associated with IP frame n+1 402). Each of frames 404, 406, 408 and 410 make up the payload of the mux PDU, called the multiplexed sublayer service data units (or mux SDUs), and are prepended with a header to make mux PDUs 412, 414, 416, and 418, respectively. The mux PDUs are delivered to modem 330 for physical layer processing, and ultimately transmission via antenna 340.

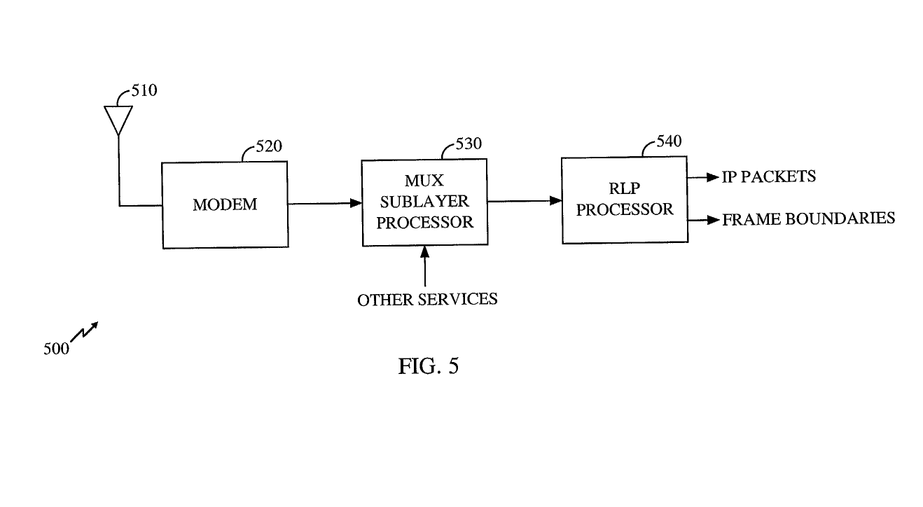

FIG. 5 depicts transmitter 500, which is suitable for deployment in wireless data system 200 as either receiver 230 or receiver 250, as shown in FIG. 2. Signals incorporating data, processed as described above with respect to FIGS. 3 and 4, are received via antenna 510 and delivered to modem 520. Modem 520 performs any necessary downconversion and baseband processing according to the air interface being employed. Data is delivered to mux sublayer processor 530, where it is demultiplexed. Data for other services is delivered to its destination (not shown), and RLP frames are delivered to RLP processor 540. RLP processor 540 performs RLP processing, as described in the RLP standard, including reconstructing the RLP frames. The data from each RLP frame corresponds to the data for an IP packet, and hence the RLP frame boundaries also provide IP framing. RLP processor 540 reconstructs IP packets from RLP frames and delivers them along with the RLP frame boundaries to their destination (not shown in FIG. 5, refer to FIG. 2 for examples).

One of the aspects of RLP is that it uses length fields to indicate packet length, so receiver 500 is relieved of the requirement to monitor each byte as it is received (as would be the requirement with flag-based framing such as HDLC). In the exemplary embodiment, a cdma2000 system, RLP is already being deployed between the PPP layer and the multiplexed sublayer, so the RLP processing is not additive to the overall processing burden.

The features of the present invention are readily applicable to the exemplary cdma2000 system, but they apply with equal force to any wireless data system in which RLP or a similar protocol is deployed. For example, this procedure is compatible with GPRS under the “native IP” option, which runs IP directly over Radio Link Control (RLC). In this situation, the RLC framing would be used to provide IP framing. RLP can be used to support native IP mode when running data services in mixed modes like MC-MAP or HDR-GPRS.

It should be noted that in all the embodiments described above, method steps can be interchanged without departing from the scope of the invention.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for transmission of Internet Protocol (IP) packets over a wireless link employing Radio Link Protocol comprising:
framing the IP packets using RLP frame boundaries.

2. A method for transmission of IP packets from a data source to a data sink over a wireless link employing RLP comprising:
partitioning the IP packets from the data source into RLP frames;
transmitting the RLP frames over the wireless link using RLP;
formatting the transmitted RLP frames into IP packets for delivery to the data sink; and
framing the IP packets using RLP frame boundaries.

3. The method of claim 2, wherein each one of the IP packets is encapsulated in one RLP frame during the partitioning step.

4. The method of claim 3, wherein each IP packet is 4096 octets or less.

5. A method for transmission of IP packets from a data source to a data sink over a wireless link employing RLP, using the Point to Point Protocol (PPP) comprising:
formatting the IP packets from the data source into PPP frames;
partitioning the PPP frames into RLP frames;
transmitting the RLP frames over the wireless link using RLP;
formatting the transmitted RLP frames into PPP frames;
formatting the PPP frames into IP packets for delivery to the data sink; and
framing the IP packets using RLP frame boundaries.

6. The method of claim 5, wherein each one of the PPP packets is encapsulated in one RLP frame during the partitioning step.

7. A method for transmission of PPP frames over a wireless link employing RLP comprising:
partitioning the PPP frames into RLP frames;
transmitting the RLP frames over the wireless link using RLP;
formatting the transmitted RLP frames into PPP frames;
framing the PPP frames using RLP frame boundaries.

8. The method of claim 7, wherein each one of the PPP packets is encapsulated in one RLP frame during the partitioning step.

9. A communications system, comprising:
a transmitter for transmitting data using RLP, comprising:
an RLP processor for accepting IP packets and partitioning the IP packets into RLP frames; and
a receiver for receiving data using RLP, comprising:
an RLP processor for producing IP packets and frame boundaries from received RLP frames and RLP frame boundaries.

10. A cdma2000 system, comprising:
a transmitter for transmitting data using RLP, comprising:
an RLP processor for accepting IP packets and partitioning the IP packets into RLP frames; and
a receiver for receiving data using RLP, comprising:
an RLP processor for producing IP packets and frame boundaries from received RLP frames and RLP frame boundaries.

11. A transmitter for transmitting data using RLP, comprising an RLP processor for accepting IP packets and partitioning the IP packets into RLP frames.

12. The transmitter of claim 11, wherein each of the IP packets is partitioned into one RLP frame

13. A receiver for receiving data using RLP, comprising an RLP processor for producing IP packets and frame boundaries from received RLP frames and RLP frame boundaries.

14. An access point in a wireless communication system comprising an RLP processor for producing IP packets and frame boundaries from received RLP frames and RLP frame boundaries.

15. An access point in a wireless communication system comprising an RLP processor for accepting IP packets and partitioning the IP packets into RLP frames.

16. An access point in a wireless communication system comprising:
a transmitter for transmitting data using RLP, comprising:
an RLP processor for accepting IP packets and partitioning the IP packets into RLP frames; and
a receiver for receiving data using RLP, comprising:
an RLP processor for producing IP packets and frame boundaries from received RLP frames and RLP frame boundaries.

17. An access terminal in a wireless communication system comprising an RLP processor for producing IP packets and frame boundaries from received RLP frames and RLP frame boundaries.

18. An access terminal in a wireless communication system comprising an RLP processor for accepting IP packets and partitioning the IP packets into RLP frames.

19. An access terminal in a wireless communication system comprising:
a transmitter for transmitting data using RLP, comprising:
an RLP processor for accepting IP packets and partitioning the IP packets into RLP frames; and
a receiver for receiving data using RLP, comprising:
an RLP processor for producing IP packets and frame boundaries from received RLP frames and RLP frame boundaries.
